(19) United States
(12) Patent Application Publication
(10) Pub. No.: US 2026/0270610 A1
(43) Pub. Date: Sep. 10, 2026

(54) Sound-Pickup Device and Display Device

(71) Applicants: HEFEI BOE VISION-ELECTRONIC TECHNOLOGY CO., LTD., Hefei, Anhui (CN); BOE TECHNOLOGY GROUP CO., LTD., Chaoyang District, Beijing (CN)

(72) Inventors: Wei Sun, Beijing (CN); Xiaojin Li, Beijing (CN); Chao Wu, Beijing (CN); Zhenjie Tao, Beijing (CN); Longhui Liu, Beijing (CN)

(21) Appl. No.: 18/994,900

(22) PCT Filed: Apr. 18, 2024
(86) PCT No.: PCT/CN2024/088557

§ 371 Date: Jan. 15, 2025

(30) Foreign Application Priority Data
May 30, 2023 (CN) 202310633087.5

(51) Int. Cl. H04R 1/28; G06F 1/16; G06F 1/18; G06F 1/183; H04R 1/06; H04R 1/08

(52) U.S. Cl. CPC H04R 1/2892; G06F 1/1658; G06F 1/181; G06F 1/183; H04R 1/06; H04R 1/086; H04R 2499/11; H04R 2499/15

(57) ABSTRACT

The present disclosure provides a sound-pickup device and a display device. The sound-pickup device includes a bracket including a first lateral plate, wherein the first lateral plate has at least one first through hole; a circuit board, including a board body and at least one sound-pickup element arranged on the board body; a first sealing assembly located between the first lateral plate; and the board body, and having at least one second through hole, an orthographic projection of which on a surface of the first lateral plate at least partially coincides with an orthographic projection of the at least one first through hole; and a fixing assembly at least partially located on one side of the circuit board away from the first lateral plate, and configured to press the circuit board against the first sealing assembly.

### CROSS-REFERENCE TO RELATED APPLICATIONS

This application is the United States national phase of PCT/CN2024/088557 filed Apr. 18, 2024, and claims priority to Chinese Patent Application No. 202310633087.5 filed May 30, 2023, the disclosures of which are hereby incorporated by reference in their entireties.

### BACKGROUND OF THE INVENTION

### Field of the Invention

The present disclosure relates to the field of an electronic device, in particular to a sound-pickup device and a display device.

### Description of Related Art

In some display devices such as a television and a monitor, sound is collected by using a sound-pickup structure. In some related technologies, the sound-pickup structure includes a visible sound-pickup hole arranged on a front face or a side face of the display device.

### SUMMARY OF THE INVENTION

It has been found through studies that, the sound-pickup structure in the related art is likely to have a poor sealing effect due to an installation error or the like, which results in noise interference.

In view of this, the embodiment of the present disclosure provides a sound-pickup device, which may improve the sound-pickup accuracy.

In one aspect of the present disclosure, a sound-pickup device is provided. The sound-pickup device includes: a bracket including a first lateral plate, wherein the first lateral plate has at least one first through hole; a circuit board including a board body and at least one sound-pickup element arranged on the board body; a first sealing assembly located between the first lateral plate and the board body, and having at least one second through hole, wherein an orthographic projection of the at least one second through hole on a surface of the first lateral plate at least partially coincides with an orthographic projection of the at least one first through hole on the surface of the first lateral plate; and a fixing assembly at least partially located on one side of the circuit board away from the first lateral plate, and configured to pressing member the circuit board against the first sealing assembly, so that the first sealing assembly seals a sound-pickup channel from the at least one first through hole to the circuit board via the at least one second through hole.

In some embodiments, the bracket further includes: a second lateral plate fixedly connected or integrally formed with the first lateral plate, wherein the fixing assembly is detachably connected with the second lateral plate.

In some embodiments, the fixing assembly includes a connecting frame and a pressing member, the connecting frame is detachably connected with the second lateral plate through a connector, and the pressing member is fixedly connected or integrally formed with the connecting frame and presses the circuit board against the first sealing assembly.

In some embodiments, the pressing member has a free end extending obliquely from the connecting frame toward the board body to form an elastic abutment against the board body.

In some embodiments, the fixing assembly includes at least one pair of pressing members in one-to-one correspondence with the at least one first through hole, and each pair of pressing members is located on both sides of a corresponding first through hole.

In some embodiments, the second lateral plate has at least one protrusion with a screwed hole, the connecting frame has a recess engaged with the at least one protrusion, the recess has a sixth through hole, and the connector includes a screw passing through the sixth through hole and threadedly connected with the screwed hole.

In some embodiments, a positioning structure is also provided between the first lateral plate and the board body.

In some embodiments, the positioning structure further includes: a positioning post disposed on a surface of the first lateral plate adjacent to the circuit board; and a positioning hole arranged on the board body and engaged with the positioning post.

In some embodiments, the first lateral plate has at least one flared portion communicating with the at least one first through hole respectively and located on one side of the at least one first through hole away from the circuit board, and a cross-sectional area of an inner cavity of the at least one flared portion gradually increases in a direction away from the circuit board.

In some embodiments, the board body has at least one third through hole, the at least one sound-pickup element is in one-to-one correspondence with the at least one third through hole, and an orthographic projection of the at least one third through hole on the surface of the first lateral plate at least partially coincides with the orthographic projection of the at least one first through hole on the surface of the first lateral plate.

In one aspect of the present disclosure, a display device is provided. The display device includes: a frame; and the above-mentioned sound-pickup device arranged on the frame.

In some embodiments, the display device further comprises: a second sealing assembly arranged between the frame and the first lateral plate and having at least one fourth through hole, wherein an orthographic projection of the at least one fourth through hole on the surface of the first lateral plate at least partially coincides with the orthographic projection of the at least one first through hole on the surface of the first lateral plate.

In some embodiments, the frame has at least one fifth through hole, the first lateral plate has at least one flared portion, and the at least one flared portion protrudes relative to a surface of the first lateral plate away from the circuit board and at least partially extends into the at least one fifth through hole.

In some embodiments, the display device further includes: a sound-transmitting cover disposed on a surface of the frame away from the first lateral plate, and completely covering the at least one fifth through hole.

In some embodiments, the cover is located on a display side of the display device.

Therefore, according to the embodiment of the present disclosure, a first sealing assembly is arranged between the first lateral plate of the bracket and the board body of the circuit board, and the circuit board is pressed against the first sealing assembly by the fixing assembly, so that the first sealing assembly achieves a more reliable sealing effect on the sound-pickup channel from the first through hole to the circuit board via the second through hole, thereby reducing the interference of external noise with the sound-pickup channel and improve the sound-pickup accuracy.

### BRIEF DESCRIPTION OF THE DRAWINGS

The accompanying drawings which constitute part of this specification, describe the embodiments of the present disclosure, and together with this specification, serve to explain the principles of the present disclosure.

The present disclosure may be more explicitly understood from the following detailed description with reference to the accompanying drawings, in which:

FIG. 1 is a schematic view of an installation structure in some embodiments of a sound-pickup device according to the present disclosure;

FIG. 2 is a schematic structural view of FIG. 1 from another perspective;

FIG. 3 is a schematic view of a section AA in FIG. 1;

FIG. 4 is a schematic view of an installation structure in some embodiments of a display device according to present disclosure;

FIG. 5 is a schematic view of an exploded structure in some embodiments of a display device according to the present disclosure;

FIG. 6 is a schematic structural view of FIG. 4 from another perspective;

FIG. 7 is a schematic view of a section BB in FIG. 4;

FIG. 8 is a schematic structural view of a frame in some embodiments of a display device according to the present disclosure;

FIG. 9 is a schematic view of a section CC in FIG. 8.

It should be understood that, the dimensions of various parts shown in the accompanying drawings are not drawn according to actual proportional relations. In addition, the same or similar components are denoted by the same or similar reference signs.

### DESCRIPTION OF THE INVENTION

Various exemplary embodiments of the present disclosure will now be described in detail with reference to the accompanying drawings. The description of the exemplary embodiments is merely illustrative but in no way intended as limiting the present disclosure and its application or use. The present disclosure may be implemented in many different forms, which are not limited to the embodiments described herein. These embodiments are provided to make the present disclosure thorough and complete, and fully convey the scope of the present disclosure to those skilled in the art. It should be noted that: the relative arrangements of members and steps, the material composition, the numerical expressions, and the numerical values elaborated in these embodiments, should be construed as merely illustrative rather than restrictive unless specifically stated otherwise.

The use of the words “first”, “second” and the like in the present disclosure do not represent any sequence, quantity or significance, but are merely intended to distinguish different parts. A word such as “include”, “comprise” or variants thereof means that the element before the word covers the element(s) listed after the word without excluding the possibility of also covering other elements. The words such as “up”, “down”, “left” and “right”, are used only to represent a relative positional relationship, and the relative positional relationship may also be changed correspondingly when the absolute position of the described object changes.

In the present disclosure, when it is described that a particular device is located between the first device and the second device, there may be present or absent with an intermediate device between the particular device and the first device or the second device. When it is described that a particular device is connected to other devices, the particular device may be directly connected to said other devices without an intermediate device, and may also not be directly connected to said other devices but with an intermediate device.

All terms (including technical terms and scientific terms) used in the present disclosure have the same meanings as understood by those of ordinary skill in the art to which the present disclosure belongs, unless otherwise specifically defined. It should also be understood that, the terms defined in, for example, general dictionaries, should be construed as having meanings that are consistent with their meanings in the context of the relevant art, but not construed in an idealized or extremely formalized sense unless specifically thus defined here.

The techniques, methods, and devices known to those of ordinary skill in the relevant art might not be discussed in detail. However, the techniques, methods, and devices shall be considered as part of the description where appropriate.

In some related technologies, the sound-pickup structure includes a visible sound-pickup hole arranged on a front face or a side face of the display device. It has been found through studies that, the sound-pickup structure in the related art is likely to have a poor sealing effect due to an installation error or the like, which results in noise interference.

In view of this, the embodiment of the present disclosure provides a sound-pickup device, which may improve the sound-pickup accuracy.

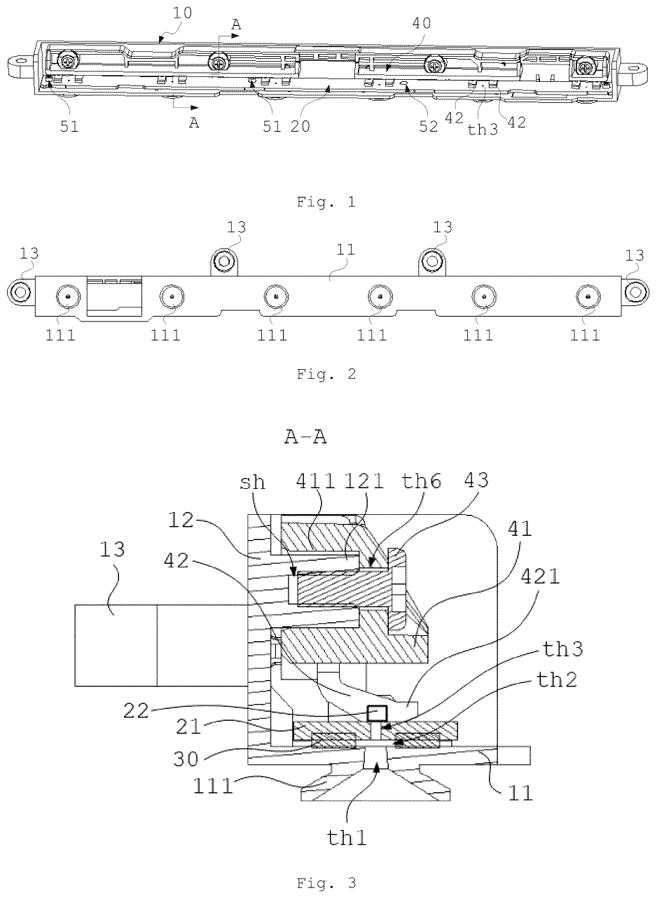

FIG. 1 is a schematic view of an installation structure in some embodiments of a sound-pickup device according to the present disclosure. FIG. 2 is a schematic structural view of FIG. 1 from another perspective. FIG. 3 is a schematic view of a section AA in FIG. 1.

Referring to FIGS. 1 to 3, the embodiment of the present disclosure provides a sound-pickup device, including: a bracket 10, a circuit board 20, a first sealing assembly 30 and a fixing assembly 40. The bracket 10 includes a first lateral plate 11 having at least one first through hole th1. The circuit board 20 includes a board body 21 and at least one sound-pickup element 22 arranged on the board body 21.

The first sealing assembly 30 is located between the first lateral plate 11 and the board body 21, and has at least one second through hole th2. An orthographic projection of the at least one second through hole th2 on a surface of the first lateral plate 11 at least partially coincides with an orthographic projection of the at least one first through hole th1 on the surface of the first lateral plate 11.

The fixing assembly 40 is at least partially located on one side of the circuit board 20 away from the first lateral plate 11, and configured to press the circuit board 20 against the first sealing assembly 30, so that the first sealing assembly 30 seals a sound-pickup channel from the at least one first through hole th1 to the circuit board 20 via the at least one second through hole th2.

In this embodiment, a first sealing assembly is arranged between the first lateral plate of the bracket and the board body of the circuit board, and the circuit board is pressed against the first sealing assembly by the fixing assembly, so that the first sealing assembly achieves a more reliable sealing effect on the sound-pickup channel from the first through hole to the circuit board via the second through hole, thereby reducing the interference of external noise with the sound-pickup channel and improve the sound-pickup accuracy.

Referring to FIGS. 1 and 3, the circuit board 20 is also referred to as a printed circuit board. The board body 21 may serve as a support for an electronic element, and serve as a carrier for electrical interconnection between the electronic elements. The sound-pickup element 22 may include a microphone, and may be located on one side of the plate 21 away from the first lateral plate 11. The board body 21 may have at least one third through hole th3, and at least one sound-pickup element is in one-to-one correspondence with the at least one third through hole th3.

The sound-pickup element 22 may be located at an orifice of the third through hole th3 or in the vicinity of the orifice. Moreover, an orthographic projection of the at least one third through hole th3 on the surface of the first lateral plate 11 at least partially coincides with an orthographic projection of the at least one first through hole th1 on the surface of the first lateral plate 11. In this way, a sealed sound-pickup channel from the first through hole th1 to the sound-pickup element 22 via the second through hole th2 and the third through hole th3 is formed.

Referring to FIG. 3, in some embodiments, the bracket 10 further includes a second lateral plate 12. The second lateral plate 12 is fixedly connected or integrally formed with the first lateral plate 11, and the fixing assembly 40 is detachably connected with the second lateral plate 12. This facilitates replacement and maintenance of the circuit board.

The first lateral plate 11 and the second lateral plate 12 may be made from the same material, for example, both made from plastic or metal, so as to facilitate forming the bracket 10 in an integrally molded manner. In other embodiments, the first lateral plate 11 and the second lateral plate 12 may also be made from different materials.

In FIG. 3, the first lateral plate 11 and the second lateral plate 12 may form an L-shaped bracket structure to enclose a space for accommodating the circuit board 20, the first sealing assembly 30 and the fixing assembly 40, which is conductive to reducing the space occupied by the sound-pickup device.

The first sealing assembly 30 may include a plurality of sealing rings, wherein a second through hole th2 is formed in a hollow portion of each sealing ring. In other embodiments, the first sealing assembly 30 may also be a sealing gasket having a plurality of second through holes th2. The material of the first sealing assembly 30 may include rubber or foam.

Referring to FIG. 3, in some embodiments, the fixing assembly 40 includes a connecting frame 41 and a pressing member 42, wherein the connecting frame 41 is detachably connected with the second lateral plate 12 through a connector 43, and the pressing member 42 is fixedly connected or integrally formed with the connecting frame 41, and presses the circuit board 20 against the first sealing assembly 30.

The connecting frame 41 and the pressing member 42 may be formed of the same material, for example, both formed of plastic or metal, so as to facilitate forming the fixing assembly 40 in an integrally molded manner. In other embodiments, the connecting frame 41 and the pressing member 42 may also be made from different materials.

Specifically, the second lateral plate 12 may have at least one protrusion 121 with a screwed hole sh. The connecting frame 41 may have a recess 411 engaged with the at least one protrusion 121, and the recess 411 has a sixth through hole th6. The connector 43 includes a screw that passes through the sixth through hole th6 and is threadedly connected with the screwed hole sh.

In order to improve the stability of the connection between the connecting frame 41 and the second lateral plate 12, two or more protrusions 121 may be engaged with two or more recesses 411 respectively. The engaged structure formed by the protrusion 121 and the recess 411 may facilitate the positioning of the connecting frame 41 on the second lateral plate 12 and the stability of the fixed connection. For example, in FIGS. 1 to 3, the second lateral plate 12 fixes the connecting frame 41 on one side of the second lateral plate 12 adjacent to the circuit board 20 by four screws.

In order to allow a more reliable sealing of the sound-pickup channel by the first sealing assembly 30, referring to FIG. 1, in some embodiments, the fixing assembly 40 includes at least one pair of pressing members 42 in one-to-one correspondence with the at least one first through hole th1, and each pair of pressing members 42 are located on both sides of a corresponding first through hole th1. This is beneficial to improve the sealing performance.

With respect to the first lateral plate 11, the connecting line between the orthographic projections of each pair of pressing members 42 at two pressing positions of the first lateral plate 11 may pass through a range corresponding to the orthographic projection of the first through hole th1, which also corresponds to a range corresponding to the orthographic projection of the third through hole th3 in FIG. 1.

Considering that there may be a poor sealing effect due to an installation error or the like when a sound-pickup structure is provided in the related art, referring to FIG. 3, in some embodiments, the pressing member 42 has a free end 421 extending obliquely from the connecting frame 41 toward the board body 21 to form an elastic abutment effect against the board body 21. By way of this elastic abutment of the free end 421 on the board body 21, it is possible to effectively absorb a cumulative tolerance of a structural member so that the board body 21 may still press the first sealing assembly 30 in a state of tolerating an installation error to certain extent, thereby achieving a better sealing effect and eliminating the interference of external noise with the sound-pickup channel.

In addition, the elastic abutment effect formed by the first sealing assembly 30 in conjunction with the pressing member 42, it is also possible to achieve a damping effect on the circuit board 20 and improve the reliability influence of the vibration of the bracket 10 over the sound-pickup element 22 on the circuit board 20.

Referring to FIG. 1, in some embodiments, a positioning structure 50 is also provided between the first lateral plate 11 and the board body 21. The positioning structure 50 may position the board body 21 on the first lateral plate 11, so as to simplify the assembling process and ensure that each third through hole th3 of the board body 21 may be aligned with each first through hole th1, which ensures the sound-pickup effect. Furthermore, by cooperating with a pressing effect of the fixing assembly 40 on the board body 21, it is possible to allow that the board body 21 is not easily disengaged from the bracket when the bracket vibrates, which ensures the sound-pickup reliability.

Specifically, in FIG. 1, the positioning structure 50 includes a positioning post 51 and a positioning hole 52. The positioning post 51 is disposed on a surface of the first lateral plate 11 adjacent to the circuit board 20. The positioning hole 52 is arranged on the board body 21 and engaged with the positioning post 51. Upon installation of the circuit board 20, the positioning posts 51 and the positioning holes 52 may realize a limiting effect on the board body 21 in at least one direction parallel to the surface of the board body 21. The fixing assembly 40 realizes a limiting effect on the board body 21 in a direction perpendicular to the surface of the board body 21 by the pressing member 42.

Referring to FIGS. 2 and 3, in some embodiments, the first lateral plate 11 has at least one flared portion 111 communicating with the at least one first through hole th1 respectively and located on one side of the at least one first through hole th1 away from the circuit board 20. The flared portion 111 may protrude relative to a surface of the first lateral plate 11 away from the circuit board 20 so as to form a bell-mouthed form.

The cross-sectional area of the inner cavity of the at least one flared portion 111 gradually increases in a direction away from the circuit board 20. In this way, the flared portion 111 has a maximum cross-sectional area at the farthest end in a direction away from the circuit board 20, which may effectively increase the sound collection area and improve the sound collection capability.

The above-described embodiments of the sound-pickup device according to the present disclosure may be applied to various electronic devices with a sound-pickup requirement, for example, a display device such as a television and a display.

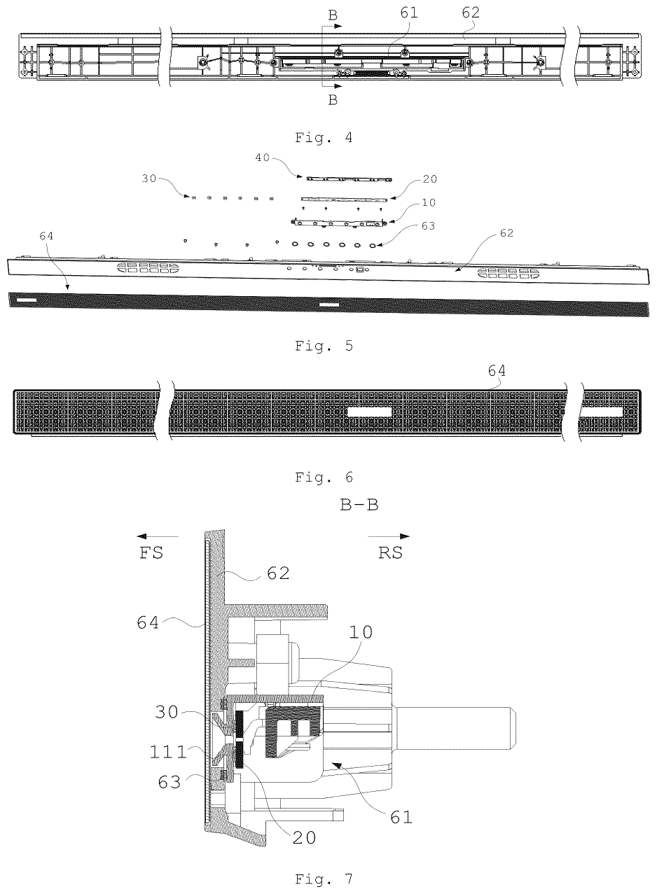

FIG. 4 is a schematic view of an installation structure in some embodiments of a display device according to present disclosure.

Referring to FIG. 4, this embodiment provides a display device, including a frame 62 and a sound-pickup device 61 according to any one of the aforementioned embodiments. The sound-pickup device 61 is arranged on the frame 62. The display device using the aforementioned sound-pickup device 61 may have a better sound-pickup effect. In FIGS. 1 and 2, the bracket 10 is also provided with a plurality of mounting portions 13. The sound-pickup device 61 may fix each mounting portion 13 on one side of the frame 62 by screws.

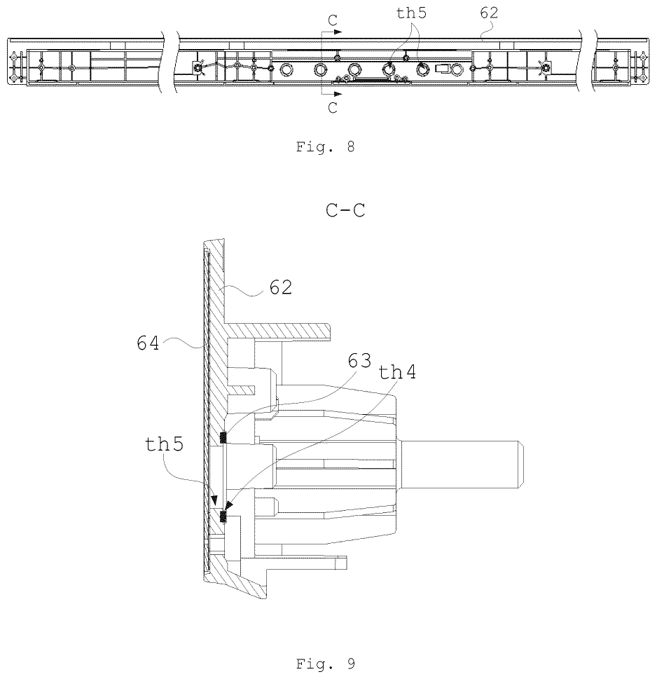

FIG. 5 is a schematic view of an exploded structure in some embodiments of a display device according to the present disclosure. FIG. 6 is a schematic structural view of FIG. 4 from another perspective. FIG. 7 is a schematic view of a section BB in FIG. 4. FIG. 8 is a schematic structural view of a frame in some embodiments of a display device according to the present disclosure. FIG. 9 is a schematic view of a section CC in FIG. 8.

Referring to FIGS. 7 to 9, in some embodiments, the frame 62 has at least one fifth through hole th5, and the first lateral plate 11 has at least one flared portion 111. The at least one flared portion 111 protrudes relative to a surface of the first lateral plate 11 away from the circuit board 20, and at least partially extends into the at least one fifth through hole th5. In this way, the flared portion 111 is at least partially accommodated in the fifth through hole th5, so that the fifth through hole th5 partially overlaps with the flared portion 111 in thickness, which is conductive to reducing the occupation of the sound-pickup device 61 in the installation space.

In FIG. 2, the first lateral plate 11 has six flared portions 111, which may be arranged at intervals along a length direction of the first lateral plate 11. In FIG. 8, the frame 62 has six fifth through holes th5 in one-to-one correspondence with the six flared portions 111.

In order to prevent dust entering or accumulating in the flared portion 111, referring to FIGS. 5 to 7, in some embodiments, the display device further includes an sound-transmitting cover 64. The sound-transmitting cover 64 is disposed on a surface of the frame 62 away from the first lateral plate 11, and completely covers the at least one fifth through hole th5. The sound-transmitting cover 64 may effectively reduce or prevent impurities such as dust from entering the flared portion 111, thereby reducing or avoiding the risk causing the sound-pickup element to fail or block the sound-pickup channel to affect the sound-pickup effect due to impurities such as dust, and also improving the influence of the flared portion 111 on the aesthetic feeling of the display device.

The sound-transmitting cover 64 may include a hard panel or a flexible mesh provided with a plurality of sound-transmitting through holes. The plurality of sound-transmitting through holes may be arranged along a surface array of the cover panel or the cover mesh.

Referring to FIG. 7, in some embodiments, the sound-transmitting cover 64 is located on a display side of the display device, so as to perform an effective sound-pickup from the display side of the display device. The display side of the display device may be a side where a display screen of the display device is provided, for example, a front side FS of the frame 62, and correspondingly, the sound-pickup device may be arranged on a rear side RS of the frame 62.

Referring to FIGS. 5 and 7, in some embodiments, the display device further includes a second sealing assembly 63. The second sealing assembly 63 is arranged between the frame 62 and the first lateral plate 11, and has at least one fourth through hole th4. The orthographic projection of the at least one fourth through hole th4 on a surface of the first lateral plate 11 at least partially coincides with the orthographic projection of the at least one first through hole th1 on a surface of the first lateral plate 11. In this way, it is possible to form a sound-pickup channel from the fourth through hole th4 to the circuit board 20 via the first through hole th1 and the second through hole th2 for sound from one side of the frame 62. The second sealing assembly 63 and the first sealing assembly 30 may form a double-layer sealing for the sound-pickup channel to improve the anti-interference function of the sound-pickup channel.

In FIG. 5, the second sealing assembly 63 may include a plurality of sealing rings, wherein a fourth through hole th4 is formed in a hollow portion of each sealing ring. In other embodiments, the second sealing assembly 63 may also be a sealing gasket having a plurality of fourth through holes th4. The material of the second sealing assembly 63 may include rubber or foam.

The display device in the embodiment of the present disclosure may be any product or member having a display function, such as a mobile phone, a tablet computer, a television, a display, a notebook computer, a digital photo frame, a navigator, and the like.

Hereto, various embodiments of the present disclosure have been described in detail. In order to avoid obscuring the concept of the present disclosure, some details commonly known in the art have not been described. From the above descriptions, those skilled in the art may fully understand how to implement the technical solutions disclosed here.

Although some specific embodiments of the present disclosure have been described in detail by way of examples, those skilled in the art should understand that the above examples are only for an illustrative purpose, rather than limiting the scope of the present disclosure. Those skilled in the art should appreciate that modifications to the above embodiments may be made or some technical features may be replaced by equivalents without departing from the scope and spirit of the present disclosure. The scope of the present disclosure is defined by the appended claims.

1. A sound-pickup device, comprising:
a bracket comprising a first lateral plate, wherein the first lateral plate has at least one first through hole;
a circuit board comprising a board body and at least one sound-pickup element arranged on the board body;
a first sealing assembly located between the first lateral plate and the board body, and having at least one second through hole, wherein an orthographic projection of the at least one second through hole on a surface of the first lateral plate at least partially coincides with an orthographic projection of the at least one first through hole on the surface of the first lateral plate; and
a fixing assembly at least partially located on one side of the circuit board away from the first lateral plate, and configured to press the circuit board against the first sealing assembly, so that the first sealing assembly seals a sound-pickup channel from the at least one first through hole to the circuit board via the at least one second through hole.

2. The sound-pickup device according to claim 1, wherein the bracket further comprises:
a second lateral plate fixedly connected or integrally formed with the first lateral plate,
wherein the fixing assembly is detachably connected with the second lateral plate.

3. The sound-pickup device according to claim 2, wherein the fixing assembly comprises a connecting frame and a pressing member, the connecting frame is detachably connected with the second lateral plate through a connector, and the pressing member is fixedly connected or integrally formed with the connecting frame and presses the circuit board against the first sealing assembly.

4. The sound-pickup device according to claim 3, wherein the pressing member has a free end extending obliquely from the connecting frame toward the board body to form an elastic abutment against the board body.

5. The sound-pickup device according to claim 3, wherein the fixing assembly comprises at least one pair of pressing members in one-to-one correspondence with the at least one first through hole, and each pair of pressing members is located on both sides of a corresponding first through hole.

6. The sound-pickup device according to claim 3, wherein the second lateral plate has at least one protrusion with a screwed hole, the connecting frame has a recess engaged with the at least one protrusion, the recess has a sixth through hole, and the connector comprises a screw passing through the sixth through hole and threadedly connected with the screwed hole.

7. The sound-pickup device according to claim 1, wherein a positioning structure is also provided between the first lateral plate and the board body.

8. The sound-pickup device according to claim 7, wherein the positioning structure further comprises:
a positioning post disposed on a surface of the first lateral plate adjacent to the circuit board; and
a positioning hole arranged on the board body and engaged with the positioning post.

9. The sound-pickup device according to claim 1, wherein the first lateral plate has at least one flared portion communicating with the at least one first through hole respectively and located on one side of the at least one first through hole away from the circuit board, and a cross-sectional area of an inner cavity of the at least one flared portion gradually increases in a direction away from the circuit board.

10. The sound-pickup device according to claim 1, wherein the board body has at least one third through hole, the at least one sound-pickup element is in one-to-one correspondence with the at least one third through hole, and an orthographic projection of the at least one third through hole on the surface of the first lateral plate at least partially coincides with the orthographic projection of the at least one first through hole on the surface of the first lateral plate.

11. A display device, comprising:
a frame; and
the sound-pickup device according to claim 1 arranged on the frame.

12. The display device according to claim 11, wherein the frame has at least one fifth through hole, the first lateral plate has at least one flared portion, and the at least one flared portion protrudes relative to a surface of the first lateral plate away from the circuit board and at least partially extends into the at least one fifth through hole.

13. The display device according to claim 12, further comprising:
a sound-transmitting cover disposed on a surface of the frame away from the first lateral plate, and completely covering the at least one fifth through hole.

14. The display device according to claim 13, wherein the sound-transmitting cover is located on a display side of the display device.

15. The display device according to claim 11, further comprising:
a second sealing assembly arranged between the frame and the first lateral plate and having at least one fourth through hole, wherein an orthographic projection of the at least one fourth through hole on the surface of the first lateral plate at least partially coincides with the orthographic projection of the at least one first through hole on the surface of the first lateral plate.
